(19) United States
(12) Patent Application Publication
(10) Pub. No.: US 2015/0083821 A1
(43) Pub. Date: Mar. 26, 2015

(54) NOZZLE UNIT AND SUBSTRATE-PROCESSING SYSTEM INCLUDING THE NOZZLE UNIT

(71) Applicant: Kookje Electric Korea Co., Ltd., Chungcheongnam-do (KR)

(72) Inventors: Yong Sung Park, Chungcheongnam-do (KR); Sung Kwang Lee, Chungcheongnam-do (KR); Dong Yeul Kim, Chungcheongnam-do (KR)

(21) Appl. No.: 14/396,119

(22) PCT Filed: Apr. 26, 2013
(86) PCT No.: PCT/KR2013/003610

§ 371 Date: Oct. 22, 2014

(30) Foreign Application Priority Data
May 25, 2012 (KR) 10-2012-0055906

(51) Int. Cl. B05C 1/00

(52) U.S. Cl. CPC B05C 1/003
USPC 239/135; 239/591

(57) ABSTRACT

A substrate treating equipment includes a process tube receiving a boat in which a plurality of substrates are loaded, a heater assembly installed to surround the process tube, a nozzle unit supplying a process gas for forming a thin film on surfaces of the substrates into the process tube. The nozzle unit includes a heating reflecting member blocking and reflecting thermal energy provided from the heater assembly.

### TECHNICAL FIELD

The inventive concept relates to a substrate treating equipment and, more particularly, to a nozzle unit and a batch type substrate treating equipment having the same.

### BACKGROUND ART

Thin film deposition methods reducing impurities and having excellent step coverage are being demanded as devices become more highly integrated. The deposition methods for the thin film include various methods such as a chemical vapor deposition (CVD) method and an atomic layer deposition (ALD) method. The CVD and ALD methods are being used well.

However, nozzles of substrate treating equipments may be formed of quartz and may be heated by a radiant heat of a heater for heating a substrate. Thus, a reaction gas provided through the nozzle to the substrate may also be heated, such that the heated reaction gas may be pyrolyzed to be supplied to the substrate.

In a general low pressure (LP)-CVD method, a cool reaction gas may be pre-heated by the pyrolysis phenomenon described above. Thus, the above phenomenon may usefully act on a gas chemical reaction. However, if a reaction gas should directly react with a surface of a high temperature substrate for formation of a thin film in the state that decomposition of the reaction gas is suppressed, the pyrolysis phenomenon occurring at the nozzle may reduce a concentration and a lifetime of the reaction gas supplied to the substrate to deteriorate quality of the thin film.

### DISCLOSURE OF THE INVENTION

### Technical Problem

Embodiments of the inventive concept may provide a nozzle unit capable of stably supplying a gas (e.g., ozone gas) weak in heat and a substrate treating equipment having the same.

Embodiments of the inventive concept may also provide a nozzle unit capable of reducing or preventing a temperature rise of a nozzle and a substrate treating equipment having the same.

### Technical Solution

In one aspect, a nozzle unit may include: a first pipe having nozzle-holes; and a heat reflecting member blocking and reflecting thermal energy transmitted toward the inside of the first pipe.

In an embodiment, the heat reflecting member may be a silica-based coating layer provided on at least one of an inner side surface and an outer side surface of the first pipe.

In an embodiment, the heat reflecting member may include a cover-plate partially surrounding the first pipe; and the cover-plate may be formed of a silica-based material.

In an embodiment, the nozzle unit may further include: a second pipe surrounding the first pipe, the second pipe having through-holes corresponding to the nozzle-holes, respectively; and a jetting pipe connecting each of the nozzle-holes to the through-hole corresponding thereto.

In an embodiment, the heat reflecting film may be further coated on at least one of an inner side surface and an outer side surface of the second pipe.

In another aspect, a substrate treating equipment may include: a process tube receiving a boat in which a plurality of substrates are loaded; a heater assembly installed to surround the process tube; and a nozzle unit supplying a process gas for forming a thin film on surfaces of the substrates into the process tube. The nozzle unit may include: a heating reflecting member blocking and reflecting thermal energy provided from the heater assembly.

In an embodiment, the heating reflecting member may include a heating reflecting film.

In an embodiment, the nozzle unit may further include: a first pipe having nozzle-holes and providing a first passage through which the process gas is supplied; and the heating reflecting member may include a cover-plate partially surrounding the first pipe. The cover-plate may be formed of a silica-based material.

In an embodiment, the nozzle unit may further include: a first pipe having nozzle-holes and providing a first passage through which the process gas is supplied; a second pipe having through-holes corresponding to the nozzle-holes, respectively, the second pipe surrounding the first pipe for preventing a temperature rise of the process gas, and a cooling gas flowing through the second pipe; and a jetting pipe connecting each of the nozzle-holes to the through-hole corresponding thereto. The process gas supplied into the first pipe may be jetted through the jetting pipes.

In an embodiment, the heat reflecting member may be a heat reflecting film coated on at least one of inner side surfaces and outer side surfaces of the first and second pipes.

In an embodiment, the heating reflecting film may be a silica-based coating film.

### Advantageous Effects

According to embodiments of the inventive concept, the radiant heat provided from the heater assembly is reflected and blocked by the heat reflecting film coated on the nozzle unit or the cover-plate. Thus, the temperature rise of the inside of the nozzle unit may be suppressed.

Additionally, the heat reflecting film may be coated on the second pipe as well as the first pipe to sufficiently block and reflect the radiant heat. Thus, it is possible to prevent the gas jetted through the first pipe from being pyrolyzed before reaching the substrate.

### BRIEF DESCRIPTION OF THE DRAWINGS

The inventive concept will become more apparent in view of the attached drawings and accompanying detailed description.

FIG. 1 is a cross-sectional view illustrating a nozzle unit according to example embodiments of the inventive concept;

FIGS. 2 and 3 illustrate heat reflecting members of a heat reflecting film form;

FIG. 4 illustrates that a heat reflecting film blocks and reflects thermal energy;

FIG. 5 illustrates a heat reflecting member of a cover-plate form;

FIG. 6 is a cross-sectional view illustrating a substrate treating equipment according to example embodiments of the inventive concept;

FIG. 7 is a perspective view illustrating a nozzle unit in FIG. 6;

FIG. 8 is an enlarged cross-sectional view of a portion of a nozzle unit in FIGS. 7; and

FIG. 9 is a plan view of a nozzle unit in FIG. 7.

### MODE FOR CARRYING OUT THE INVENTION

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

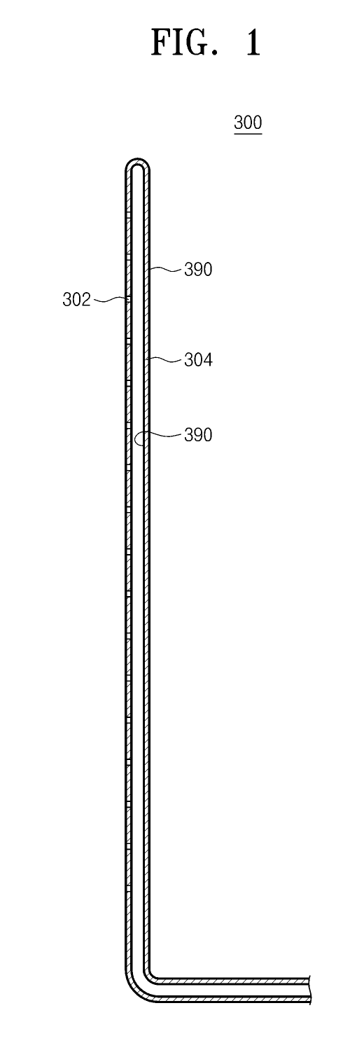

FIG. 1 is a cross-sectional view illustrating a nozzle unit according to embodiments of the inventive concept.

Referring to FIG. 1, a nozzle unit 300 includes a long nozzle pipe 304. The nozzle pipe 304 has nozzle-holes 302. The nozzle pipe 304 is formed of a quartz material. A heat reflecting member may be provided to the nozzle pipe 304. The heat reflecting member may block and reflect thermal energy. The heat reflecting member may be provided in a coating film form to the nozzle pipe 304. Alternatively, the heat reflecting member may be provided in a plate form surrounding the nozzle pipe 304.

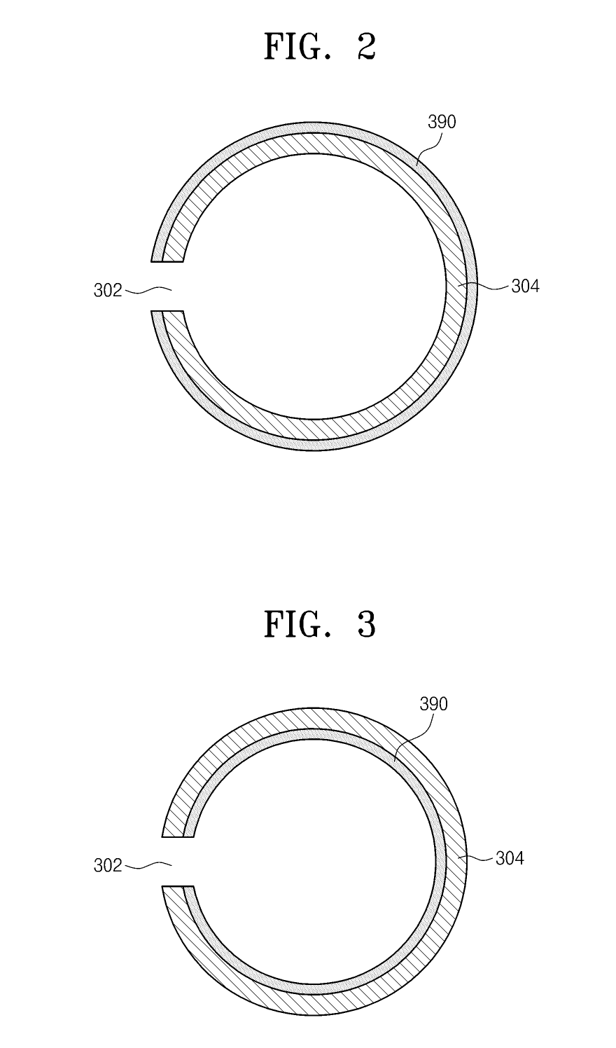

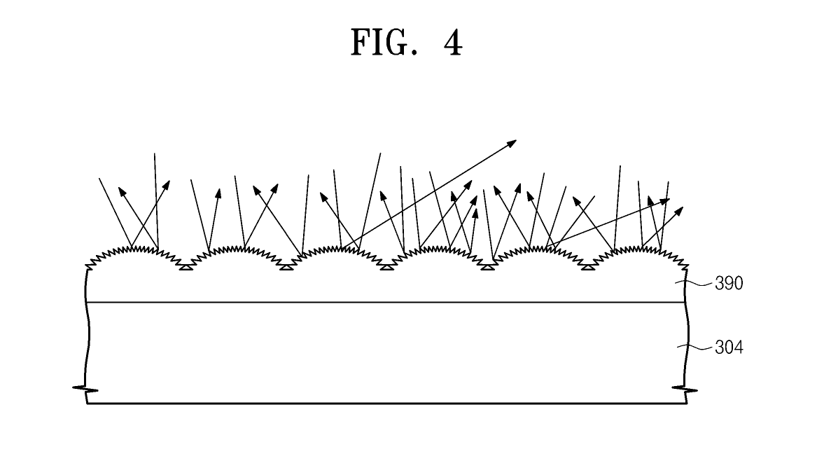

As illustrated in FIGS. 2 and 3, the heat reflecting member may be a heat reflecting film 390 formed on an inner side surface and/or an outer side surface of the nozzle pipe 304. As illustrated in FIG. 4, the heat reflecting layer 390 is provided in order to block and reflect the thermal energy supplied from the outside of the nozzle pipe 304. The heat reflecting film 390 is formed of a silica-based coating film. The nozzle unit 300 coated with the heat reflecting layer 390 may be very valuably used in a substrate treating equipment requiring stable supply of a gas (e.g., ozone gas) weak in heat during a thin film deposition process.

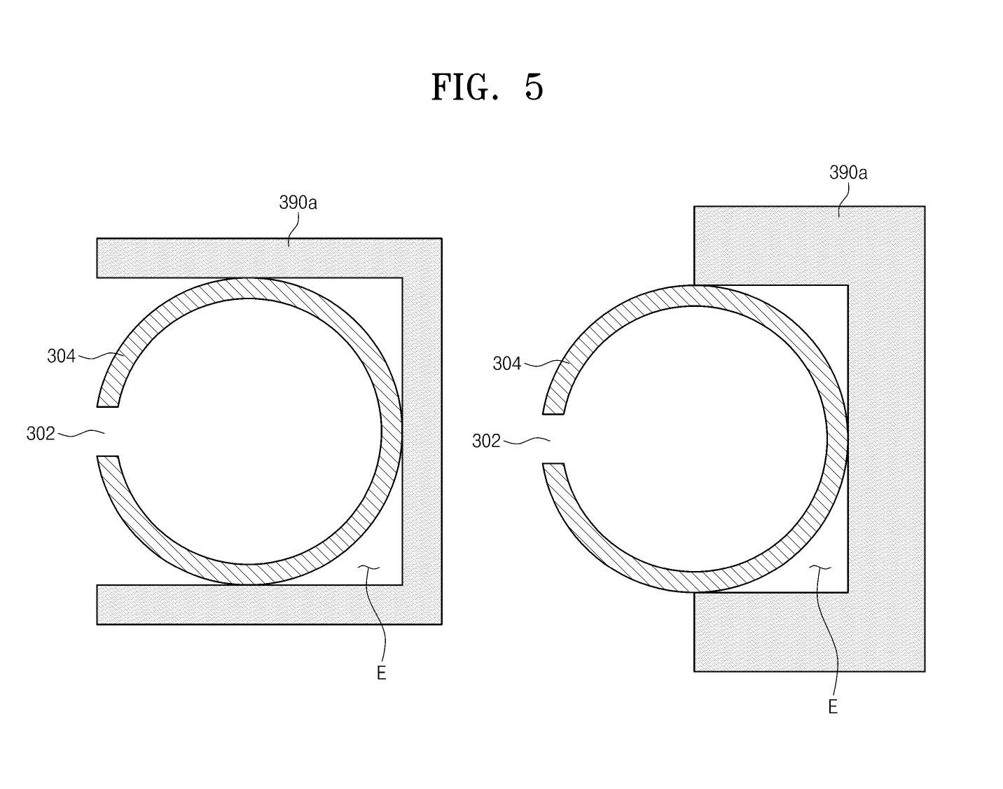

Alternatively, as illustrated in FIG. 5, the heat reflecting member may be a cover-plate 390a having one of various shapes surrounding the nozzle pipe 304 having the nozzle-holes 302. The cover-plate 390a has a space E in which the nozzle pipe 304 is located. The cover-plate 390a is formed of a silica-based material. The cover-plate 390a protects the nozzle pipe 304 from the thermal energy supplied from the outside.

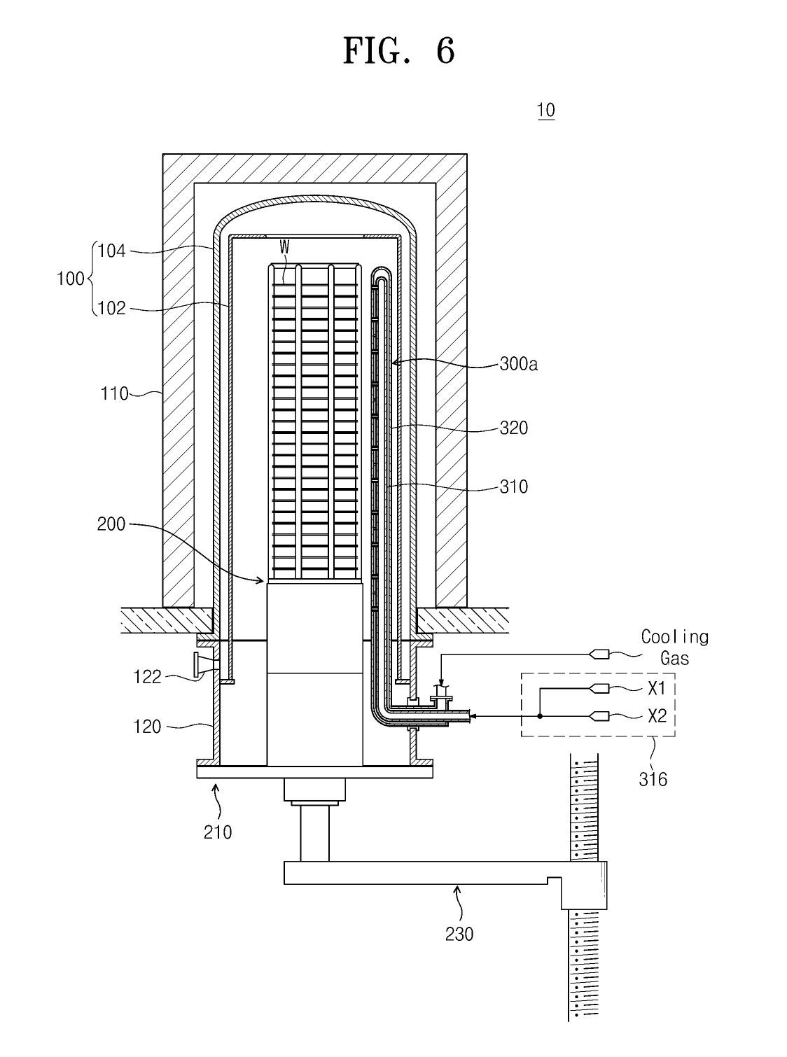

FIG. 6 is a cross-sectional view illustrating a substrate treating equipment according to example embodiments of the inventive concept.

Referring to FIG. 6, a substrate treating equipment 10 according to the inventive concept includes: a boat 200 in which a plurality of substrates W are loaded; a process tube 100 having an outer tube 104 and an inner tube 102 and receiving the boat 200; a heater assembly 110 surrounding the process tube 100; a seal cap 210 supporting the boat 200 and connected to a flange 120 of the process tube 100; and a nozzle unit 300a supplying gasses for depositing a thin film on a surface of the substrate into the process tube 100.

[Process Tube]

The process tube 100 has a hollow cylindrical shape of a dome shape. The process tube 100 includes an inner space in which the boat 200 including the substrates W is loaded. A thin film deposition process is performed on the substrates W in the inner space of the process tube 100. The process tube 100 may be formed of a material standing the heat of a high temperature, for example, quartz.

An exhaust port 122 may be installed at a side of the flange 120 of the process tube 100. The exhaust port 122 is provided to forcibly inhaling air in the process tube 100 for decompressing the inner space of the process tube 100. The nozzle unit 300a for supplying a process gas into the process tube 100 may be installed at another side of the flange 120 opposite to the exhaust port 122. The exhaust port 122 is provided for exhausting the air in the process tube 100 to the outside of the process tube 100 when the deposition process is performed. The exhaust port 122 is connected to an exhaust line (not shown). The process gas supplied to the process tube 100 is exhausted through the exhaust port 122, and the inner space of the process tube 100 is decompressed through the exhaust port 122.

[Boat]

The boat 200 includes slots in which 50 or more substrates W (e.g., wafers) are inserted. The boat 200 is mounted on the seal cap 210. The seal cap 210 may be loaded into the process tube 100 or be unloaded from the process tube 100 by a driving part 230 corresponding to an elevating device. If the boat 200 is loaded in the process tube 100, the seal cap 210 is combined with the flange 120 of the process tube 100. In an embodiment, a sealing member such as an 0-ring may be provided in a contact region of the seal cap 210 and the flange 120 of the process tube 100 in order that the process gas is not leaked between the process tube 100 and the seal cap 210.

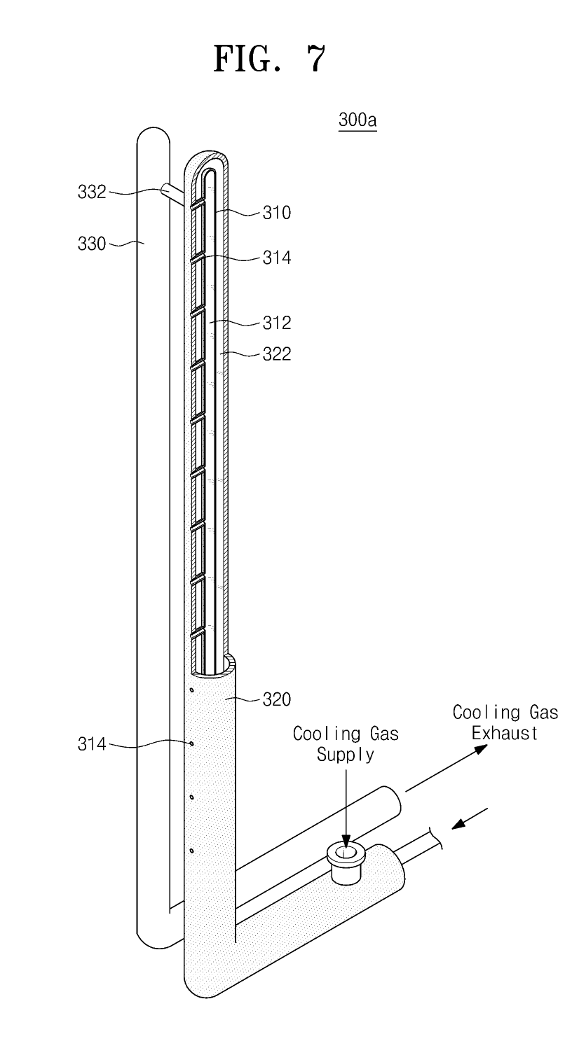

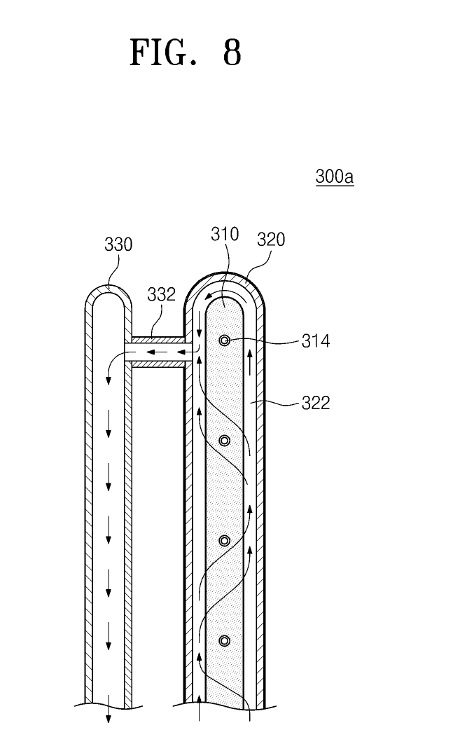

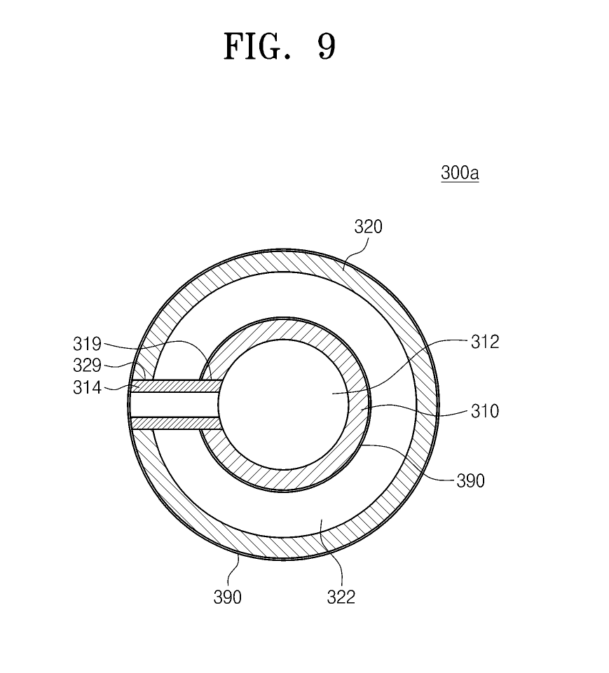

FIG. 7 is a perspective view illustrating a nozzle unit in FIG. 6. FIG. 8 is an enlarged cross-sectional view of a portion of a nozzle unit in FIG. 7. FIG. 9 is a plan view of a nozzle unit in FIG. 7.

[Nozzle Unit]

Referring to FIGS. 6 to 9, the nozzle unit 300a includes a first pipe 310, a second pipe 320, and an exhaust pipe 330 in order that the gas (e.g., the ozone gas) weak in the heat maintains its properties.

The first pipe 310 is disposed within the second pipe 320. The first pipe 310 may sequentially jet a first gas and a second gas for forming the thin film to the substrates W loaded in the boat 200. The first gas is provided for forming a precursor layer on the top surface of the substrate. The second gas is an oxidizer for oxidizing the precursor layer. The precursor layer is oxidized by the second gas to form a metal oxide layer. The ozone gas may be mainly used as the oxidizer. An external gas supply part 316 may sequentially provide the first gas xl and the second gas x2 into the first pipe 310. The gases xl and x2 may be supplied into a first passage of the first pipe 310 to be jetted toward the substrate through jetting pipes 314. The first passage is provided within the first pipe 310. The jetting pipe 314 connects a nozzle-hole 319 of the first pipe 310 to a through-hole 329 of the second pipe 320.

A heat reflecting film 390 is coated on an outer circumference surface of the first pipe 310. The heat reflecting film 390 blocks and reflects thermal energy supplied from the heater assembly 110. The heat reflecting film 390 may be a silica-based coating film. Even though not shown in the drawings, the heat reflecting film 390 may also be provided on an inner circumference surface of the first pipe 310. For example, the second gas x2 may include at least one oxidizer including an activated oxidizer generating oxygen radicals. The activated oxidizer may include ozone (O3), plasma oxygen (O2), remote plasma oxygen (O2), and/or plasma nitrous oxide (N2O) which are formed by a plasma generator. Additionally, the second gas x2 may further include at least one of various reaction gases (e.g., SiH4, DCS, PH3, B2H6, TiCl4, and TSA) and various organic sources (e.g., TEMAZr, TEMAHf, and TMA).

In FIG. 6, a distance between the jetting pipes 314 of the first pipe 310 is greater than a distance between the substrates W. However, the inventive concept is not limited thereto. In another embodiment, the jetting pipes 314 of the first pipe 310 may be densely arranged in order that the gasses are jetted between the substrates W as occasion demands. In this case, reactivity of the gases may be improved on the substrates, and the amount of the gases used in the process may be optimized to reduce unnecessary gas consumption.

The second pipe 320 is formed to surround the first pipe 310. Even though not shown in the drawings, the second pipe 320 may include a first body and a second body which are assembled with each other for the convenience of the fabrication of the second pipe 320. A second passage 322 may be provided between the second pipe 320 and the first pipe 310. A cooling gas is supplied into the second passage 322 from the outside. The heat reflecting film 390 may also be coated on an outer circumference surface of the second pipe 320. The heat reflecting film 390 of the second pipe 320 blocks and reflects the thermal energy provided from the heater assembly 110. The heat reflecting film 390 may be further provided on an inner circumference surface of the second pipe 320. The second pipe 320 prevents the first pipe 310 from being heated by a radiant heat provided from the heater assembly 110. The heat reflecting film 390 coated on the outer circumference surface of the second pipe 320 may reflect or block the radiant heat, and the cooling gas supplied into the second passage 322 may absorb the radiant heat and then may be exhausted outside the process tube 100 through the separate exhaust pipe 330. Nitrogen gas, argon gas, and/or helium gas may be used as the cooling gas.

A temperature rise of the gas flowing through the first pipe 310 may be minimized by the heating reflecting film 390 coated on the outer circumference surface of the second pipe 320, the heating reflecting film 390 coated on the outer circumference surface of the first pipe 310, and the cooling gas supplied into the second passage 322 of the second pipe 320. A connection pipe 332 is connected between a top end portion of the second pipe 320 and a top end portion of the exhaust pipe 330. The cooling gas that is supplied into the second passage 322 and then is heated may be exhausted to the outside of the nozzle unit 300a through the connection pipe 332 and the exhaust pipe 330.

Even though not shown in the drawings, the nozzle unit 300a may not include the exhaust pipe 330. In this case, the cooling gas may be supplied and exhausted through the second pipe 320.

According to the nozzle unit 300a described above, even though the inner temperature of the process tube 100 reaches a high temperature by the radiant heat provided from the heater assembly 110, the heat reflecting film 390 coated on the outer circumference surfaces of the first and second pipes 310 and 320 reflect and block the radiant heat and the cooling gas supplied into the second passage 322 absorbs the radiant heat provided to the first pipe 310. As a result, the temperature rise of the first pipe 310 may be minimized or prevented.

As described above, the first and second pipes 310 and 320 having the heat reflecting film 390 and the cooling gas in the second pipe 320 suppress the temperature rise of the first pipe 310, such that the second gas x2 jetted through the first pipe 310 may be prevented from being pyrolyzed before reaching the substrate. As a result, the quality of an oxide film formed on the substrate may be improved, and the amount of the process gas used in the process may be reduced to reduce fabricating costs of the oxide film.

Even though not shown in the drawings, the heat reflecting film may also be provided on the inner circumference surfaces as well as the outer circumference surfaces of the first and second pipes 310 and 320.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

1. A nozzle unit comprising:
a first pipe having nozzle-holes; and
a heat reflecting member blocking and reflecting thermal energy transmitted toward the inside of the first pipe.

2. The nozzle unit of claim 1, wherein the heat reflecting member is a silica-based coating layer provided on at least one of an inner side surface and an outer side surface of the first pipe.

3. The nozzle unit of claim 1, wherein the heat reflecting member includes a cover-plate partially surrounding the first pipe; and
wherein the cover-plate is formed of a silica-based material.

4. The nozzle unit of claim 1, further comprising:
a second pipe surrounding the first pipe, the second pipe having through-holes corresponding to the nozzle-holes, respectively; and
a jetting pipe connecting each of the nozzle-holes to the through-hole corresponding thereto.

5. The nozzle unit of claim 4, wherein the heat reflecting film is further coated on at least one of an inner side surface and an outer side surface of the second pipe.

6. A substrate treating equipment comprising:
a process tube receiving a boat in which a plurality of substrates are loaded;
a heater assembly installed to surround the process tube; and
a nozzle unit supplying a process gas for forming a thin film on surfaces of the substrates into the process tube,
wherein the nozzle unit comprises: a heating reflecting member blocking and reflecting thermal energy provided from the heater assembly.

7. The substrate treating equipment of claim 6, wherein the heating reflecting member includes a heating reflecting film.

8. The substrate treating equipment of claim 6, wherein the nozzle unit further comprises: a first pipe having nozzle-holes and providing a first passage through which the process gas is supplied;
wherein the heating reflecting member includes a cover-plate partially surrounding the first pipe; and
wherein the cover-plate is formed of a silica-based material.

9. The substrate treating equipment of claim 6, wherein the nozzle unit further comprises:
a first pipe having nozzle-holes and providing a first passage through which the process gas is supplied;
a second pipe having through-holes corresponding to the nozzle-holes, respectively, the second pipe surrounding the first pipe for preventing a temperature rise of the process gas, and a cooling gas flowing through the second pipe; and
a jetting pipe connecting each of the nozzle-holes to the through-hole corresponding thereto,
wherein the process gas supplied into the first pipe is jetted through the jetting pipes.

10. The substrate treating equipment of claim 9, wherein the heat reflecting member is a heat reflecting film coated on at least one of inner side surfaces and outer side surfaces of the first and second pipes.

11. The substrate treating equipment of claim 7, wherein the heating reflecting film is a silica-based coating film.
